(19) United States
(12) Patent Application Publication
(10) Pub. No.: US 2010/0114835 A1
(43) Pub. Date: May 6, 2010

(54) CENTRALIZED MANAGING SYSTEM AND METHOD FOR MANAGING INDUSTRIAL STORAGE DEVICES

(75) Inventor: Wen-Sen Tsai, Jhubei City (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Accusys, Inc.

(21) Appl. No.: 12/363,965

(22) Filed: Feb. 2, 2009

(30) Foreign Application Priority Data
Oct. 30, 2008 (TW) 97141896

(51) Int. Cl. G06F 17/30; G06F 7/00

(52) U.S. Cl. 707/654; 707/E17.005

(57) ABSTRACT

A centralized managing system for an industrial data storage is provided. The centralized managing system includes at least one industrial apparatus outputting a first interface datum; at least one serial converting interface connected with the industrial device, and converting the first interface datum into a second interface datum; a hub device connected with the at least one serial converting interface, and receiving and transmitting the second interface datum; and at least one storage device connected with the hub device, and storing the second interface datum.

### CROSS REFERENCE TO RELATED APPLICATIONS

This application claims priority to Taiwan Application No. 97141896, filed Oct. 30, 2008.

### FIELD OF THE INVENTION

The present invention relates to a managing system and the method for managing industrial storage devices, and more particular to a centralized managing system and the method for managing industrial storage devices.

### BACKGROUND OF THE INVENTION

The present industrial equipments are usually designed as two parts, wherein one part is the engineering execution apparatus and the other is the storage apparatus, as shown in FIG. 1. Moreover, among the present storage apparatuses, the hard disk is the main stream and used as the storage apparatus in the industrial equipment, due to the facts of the large storing capacity, the fast accessing velocity and the low cost.

The industrial equipments are usually operated in harsh environments, e.g. under the extremely high or low temperature, in the vacuum chamber or in the shaking environment, and the stored data therein mostly belong to the formats not supporting the internet access, such as the IDE, the SCSI or the SATA formats. Among the mentioned formats, the length of the cable line in the standards of the IDE format has to be shorter than 45 cm, the length of the cable line in the standards of the SATA format has to be shorter than 2 m, and the length of the cable line in the standards of the SCSI format has to be shorter than 3 m, which means that the industrial apparatus 1 and the storage apparatus 2 have to be set together in the mentioned harsh environments in the present standard as shown in FIG. 1. However, the storage apparatus 2 is unlikely to stand those harsh conditions and thus might be damaged. Once the storage apparatus 2 and the data saved therein are damaged, the industrial process will be disrupted which leads to loss. Besides, the storage apparatus 2 has to be repaired or replaced and the data have to be recovered, wherein each of these tasks increases the loss scale. On the other hand, it is difficult to manage such structure where the industrial apparatus 1 and the storage apparatus 2 are set together. Specially, it usually takes more extra money, labors and time to backup and recover the damaged data with the broken storage apparatus 2.

For preventing the process interruption and the data loss caused by the damaged storage devices and for improving the managing method, a centralized managing system and the method for managing industrial storage devices are provided in the present invention.

### SUMMARY OF THE INVENTION

In accordance with an aspect of the present invention, a centralized managing system for an industrial data storage is provided. The centralized managing system comprises at least one industrial apparatus outputting a first interface datum; at least one serial converting interface connected with the industrial device, and converting the first interface datum into a second interface datum; a hub device connected with the at least one serial converting interface, and receiving and transmitting the second interface datum; and at least one storage device connected with the hub device, and storing the second interface datum.

According to the centralized managing system described above, the first interface datum has a format being one selected from a group consisting of a IDE, a SCSI and a SATA formats which are accessible for the industrial apparatus.

According to the centralized managing system described above, the second interface datum has a format being one selected from a group consisting of a FDDI, an Ethernet, a SAN, a NAS and an iSCSI formats which are accessible for an internet.

According to the centralized managing system described above, the at least one storage device is connected with an external network, through which accessing the second interface datum.

According to the centralized managing system described above, the at least one industrial apparatus comprises a connecting interface connecting with the at least one serial converting interface.

According to the centralized managing system described above, the hub device includes a first hub connected with the at least one serial converting interface and a second hub connected to the at least one storage device.

According to the centralized managing system described above, the first and the second hubs are connected with each other via one selected from a group consisting of a coaxial cable, an internet line or a fiber cable.

According to the centralized managing system described above, the first and the second hubs are switch hubs, and the second hub is configured for distributing the second interface datum to the at least one storage device.

In accordance with another aspect of the present invention, an integrated managing method is provided. The integrated managing method comprises steps of generating a first interface datum; converting the first interface datum into a second interface datum; distributing and storing the second interface datum; and accessing and managing the second interface datum via an external network.

According to the integrated managing method described above, the first interface datum has a format being one selected from a group consisting of a IDE, a SCSI and a SATA formats which are accessible for an industrial device.

According to the integrated managing method described above, the second interface datum has a format being one selected from a group consisting of a FDDI, an Ethernet, a SAN, a NAS and an iSCSI formats which are accessible for an internet.

According to the integrated managing method described above, the second interface datum is distributed into at least one storage device by a hub device.

In accordance with a further aspect of the present invention, a remote managing system for an industrial data storage is provided. The remote managing system for an industrial data storage comprises an industrial apparatus outputting a first interface datum; a serial converting interface connected with the connecting interface, and converting the first interface datum into a second interface datum; and a storage device connected with the serial converting interface, and storing the second interface datum.

According to the remote managing system described above, the first interface datum has a format being one selected from a group consisting of a IDE, a SCSI and a SATA formats which are accessible for the industrial apparatus.

According to the remote managing system described above, the second interface datum has a format being one selected from a group consisting of a FDDI, an Ethernet, a SAN, a NAS and an iSCSI formats which are accessible for an internet.

According to the remote managing system described above, the storage device is connected with an external network, through which the second interface datum is accessed.

According to the remote managing system described above, the industrial apparatus comprises a connecting interface connecting with the serial converting interface.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a diagram of the conventional industrial equipment;

FIG. 2 is a diagram of the centralized managing system for industrial storage devices according to the first preferred embodiment of the present invention;

FIG. 3 is a diagram of the centralized managing system for industrial storage devices according to the second preferred embodiment of the present invention;

FIG. 4 is a diagram of the centralized managing system for industrial storage devices according to the third preferred embodiment of the present invention; and

FIG. 5 is a flow chart of the centralized managing method for industrial storage devices in the present invention.

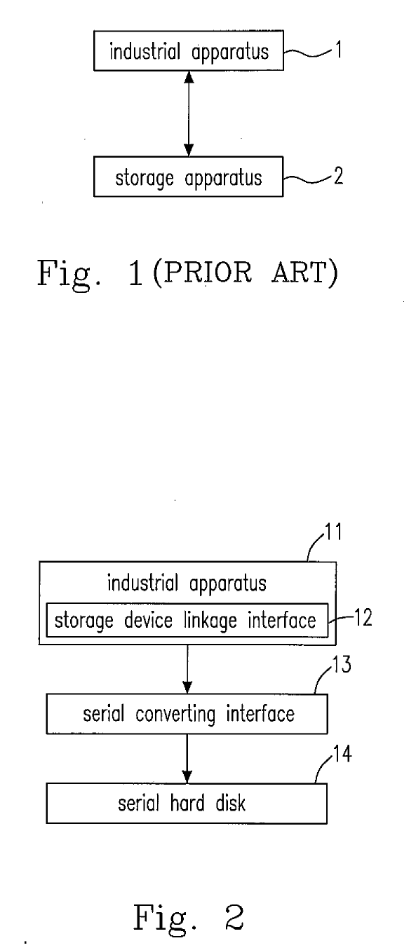

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

Please refer to FIG. 2, which is a diagram of the centralized managing system for industrial storage devices according to the first preferred embodiment of the present invention. The centralized managing system includes an industrial apparatus 11 comprising a storage device linkage interface 12, a serial converting interface 13 connected to the storage device linkage interface 12, and a serial hard disk 14 connected to the serial converting interface 13.

When a datum is generated by the industrial apparatus 11, it will be transferred to the serial converting interface 13 through the storage device linkage interface 12. The datum is an apparatus accessible format datum, such as the IDE, SATA or SCSI format, and will be converted into an internet accessible format, such as the FDDI, Ethernet, SAN, NAS or iSCSI format, by the serial converting interface 13. Then, the internet accessible format datum is transmitted to the serial hard disk 14 and stored therein, which is far from the industrial apparatus 11, through the network equipments, such as the coaxial cable, the Ethernet line, or the fiber cable, etc. In this way, the transmitting distance can be boundlessly extended without limitation. Therefore, the serial hard disk 14 can be configured far from the harsh environment where the industrial apparatus 11 is configured, even in another room or building.

Contrarily, when the industrial apparatus 11 needs a parameter datum for operation, the parameter datum will be accessed from the serial hard disk 14 to the serial converting interface 13 for being converted back into the apparatus accessible format. Then, the parameter datum is transferred to the storage device linkage interface 12 and accessed by the industrial apparatus 11 to perform the operation.

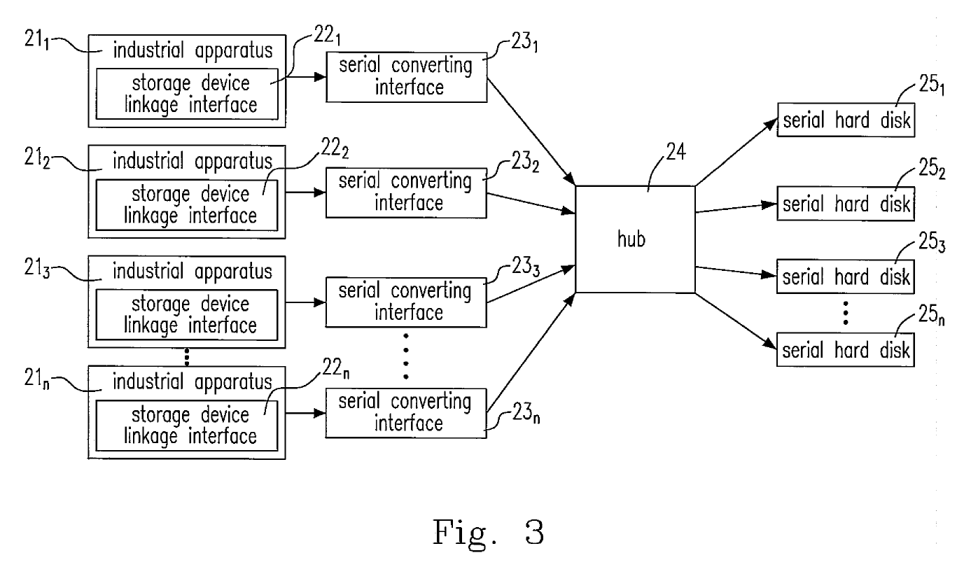

Please refer to FIG. 3, which is a diagram of the centralized managing system for industrial storage devices according to the second preferred embodiment of the present invention. The centralized managing system includes plural industrial apparatuses 21 _{1,2,3, . . . n}, plural serial converting interfaces 23_{1,2,3, . . . n}, a hub 24, and plural serial hard disks 24_{1,2,3, . . . n}. Each industrial apparatus 21_{1,2,3, . . . n} has a storage device linkage interface 22_{1,2,3, . . . n}, and each storage device linkage interface 22_{1,2,3, . . . n} is connected to a serial converting interface 23_{1,2,3, . . . n}. The serial converting interfaces 23_{1,2,3, . . . n} are all connected to the hub 24, and the plural serial hard disks 25_{1,2,3, . . . n} are also connected to the hub 24.

As a datum is generated by one of the plural industrial apparatuses 21_{1,2,3, . . . n}, it will be transferred to the serial converting interface 23_{1,2,3, . . . n} through the storage device linkage interface 22_{1,2,3, . . . n}. The datum is an apparatus accessible format datum, such as the IDE, SATA or SCSI format, and will be converted into an internet accessible format, such as the FDDI, Ethernet, SAN, NAS or iSCSI format, by the serial converting interface 23_{1,2,3, . . . n}. Then, the datum will be transmitted to the hub 24, which serves as a switch to distribute the datum into the serial hard disks 25_{1,2,3, . . . n}. Finally, the datum is distributed and stored in the serial hard disks 25_{1,2,3, . . . n} Because the datum is converted into the internet accessible format, it is able to be transmitted by using the network equipments, such as the coaxial cable, the Ethernet line, or the fiber cable, etc., between the serial converting interface 23_{1,2,3, . . . n} and the hub 24, or between the hub 24 and the serial hard disks 25_{1,2,3, . . . n} l Since the network equipments can be boundlessly extended without limitation, the serial hard disks 25_{1,2,3, . . . n} can be configured far from the harsh environment where the industrial apparatuses 21_{1,2,3, . . . n} are configured, even in another room or building.

Similarly, the industrial apparatus 21_{1,2,3, . . . n} can access the parameter data from the serial hard disks 25_{1,2,3, . . . n} through the hub 24, the serial converting interface 23_{1,2,3, . . . n} and the storage device linkage interface 22_{1,2,3, . . . n}. In this case, the parameter datum is reversely transmitted to the serial converting interface 23_{1,2,3, . . . n} and converted back into the apparatus accessible format. Then, the converted parameter datum is read into the industrial apparatus 21_{1,2,3, . . . n} via the storage device linkage interface 22_{1,2,3, . . . n}. Since the datum is distributed by the hub 24 and stored in the corresponding serial hard disk 25_{1,2,3, . . . n}, the datum required by each industrial apparatus 21_{1,2,3, . . . n} can be found in the corresponding serial hard disk 25_{1,2,3, . . . n} rapidly; it is unnecessary to search among the serial hard disks 25_{1,2,3, . . . n} one by one.

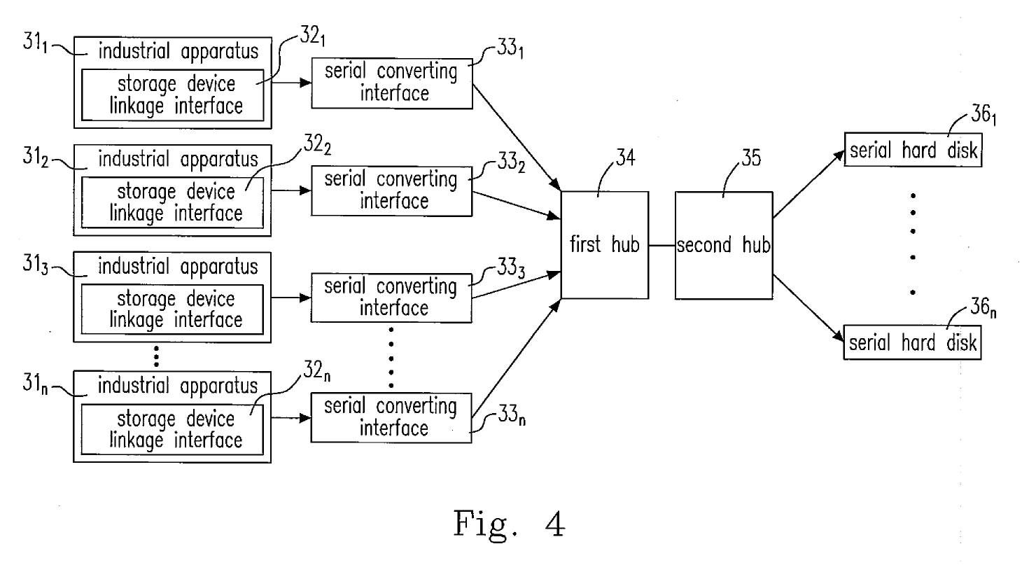

Please refer to FIG. 4, which is a diagram of the centralized managing system for industrial storage devices according to the third preferred embodiment of the present invention. The centralized managing system includes plural industrial apparatuses 31_{1,2,3, . . . n}, plural serial converting interfaces 33_{1,2,3, . . . n}, a first hub 34, a second hub 35 and plural serial hard disks 36_{1,2,3, . . . n}. Each industrial apparatus 31_{1,2,3, . . . n} has a storage device linkage interface 32_{1,2,3, . . . n}, and each storage device linkage interface 32_{1,2,3, . . . n} is connected to a serial converting interface 33_{1,2,3, . . . n}. The serial converting interfaces 33_{1,2,3, . . . n} are all connected to the first hub 34, the plural serial hard disks 36_{1,2,3, . . . n} are all connected to the second hub 35, and the first and the second hubs 34,35 are connected with each other.

While a datum is generated by one of the plural industrial apparatuses 31_{1,2,3, . . . n}, it will be transferred to the serial converting interface 33_{1,2,3, . . . n} through the storage device linkage interface 32_{1,2,3, . . . n}. The datum is an apparatus accessible format datum, such as the IDE, SATA or SCSI format, and will be converted into an internet accessible format, such as the FDDI, Ethernet, SAN, NAS or iSCSI format, by the serial converting interface 33_{1,2,3, . . . n}. Then, the datum will be transmitted to the first hub 34, and then to the second hub 35. The first hub 34 serves as a switch to accept the datum from the plural serial converting interfaces 33_{1,2,3, . . . n}, and the second hub 35 serves as a switch to distribute the datum into the serial hard disks 36_{1,2,3, . . . n}. Finally, the datum is distributed and stored in the serial hard disks 36_{1,2,3, . . . n}. Because the datum is converted into the internet accessible format, it is able to be transmitted by using the network equipments, such as the coaxial cable, the Ethernet line, or the fiber cable, etc., between the serial converting interface 33_{1,2,3, . . . n} and the first hub 34, between the first hub 34 and the second hub 35 or between the second hub 35 and the serial hard disks 36_{1,2,3, . . . n}. Because the network equipments can be boundlessly extended without limitation, the serial hard disks 35_{1,2,3, . . . n} can be configured far from the harsh environment where the industrial apparatuses 31_{1,2,3, . . . n} are configured, even in another room or building.

Similarly, the industrial apparatus 31_{1,2,3, . . . n} can access the parameter data from the serial hard disks 36_{1,2,3, . . . n} through the first and the second hubs 34,35, the serial converting interface 33_{1,2,3, . . . n} and the storage device linkage interface 32_{1,2,3, . . . n}. In this case, the parameter datum is reversely transmitted to the serial converting interface 33_{1,2,3, . . . n} and converted into the apparatus accessible format. Then, the converted parameter datum is read into the industrial apparatus 31_{1,2,3, . . . n} via the storage device linkage interface 32_{1,2,3 . . . n}. Since the datum is distributed by the second hub 35 and stored in the corresponding serial hard disk 36_{1,2,3, . . . n} the datum required by each industrial apparatus 31_{1,2,3, . . . n} can be found in the corresponding serial hard disk 36_{1,2,3, . . . n} rapidly; it is unnecessary to search among the serial hard disks 36_{1,2,3, . . . n} one by one.

Furthermore, since the data are stored in the serial hard disks 14, 25_{1,2,3, . . . n}, 36_{1,2,3 . . . n} in the internet accessible format, the serial hard disks 14, 25_{1,2,3, . . . n}, 36_{1,2,3, . . . n} can be further linked to the external network, so that it is more convenient for the users to remotely operate the data access in different places. With such configuration, it is unnecessary to shut the industrial apparatuses 11, 21_{1,2,3, . . . n}, 31_{1,2,3, . . . n}, when backuping or maintaining the data, or even when exchanging the hard disks in the serial hard disks 14, 25_{1,2,3, . . . n}, 36_{1,2,3, . . . n}. Therefore, the efficiency will be raised and the loss caused by the data damage will be decreased.

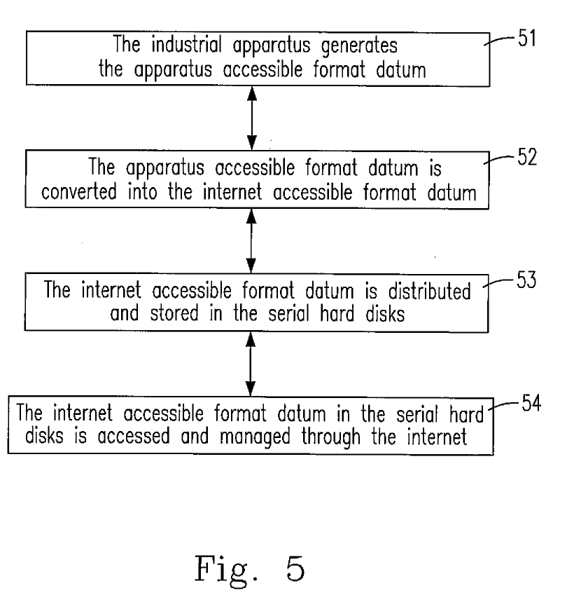

Please refer to FIG. 5, which is a flow chart of the centralized managing method for industrial storage devices in the present invention. In the beginning, the industrial apparatus generates the apparatus accessible format datum (step 51). Next, the apparatus accessible format datum is converted into the internet accessible format datum (step 52). Subsequently, the internet accessible format datum is distributed and stored in the serial hard disks (step 53). Finally, the internet accessible format datum in the serial hard disks is accessed and managed through the internet (step 54).

Based on the above, the present invention provides an easier way to access and manage the data far from the harsh environment where the industrial apparatuses are configured, which can significantly decrease the risk of the data damage.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A centralized managing system for an industrial data storage, comprising:
at least one industrial apparatus outputting a first interface datum;
at least one serial converting interface connected with the industrial device, and converting the first interface datum into a second interface datum;
a hub device connected with the at least one serial converting interface, and receiving and transmitting the second interface datum; and
at least one storage device connected with the hub device, and storing the second interface datum.

2. A centralized managing system as claimed in claim 1, wherein the first interface datum has a format being one selected from a group consisting of a IDE, a SCSI and a SATA formats which are accessible for the industrial apparatus.

3. A centralized managing system as claimed in claim 1, wherein the second interface datum has a format being one selected from a group consisting of a FDDI, an Ethernet, a SAN, a NAS and an iSCSI formats which are accessible for an internet.

4. A centralized managing system as claimed in claim 1, wherein the at least one storage device is connected with an external network, through which accessing the second interface datum.

5. A centralized managing system as claimed in claim 1, wherein the at least one industrial apparatus comprises a connecting interface connecting with the at least one serial converting interface.

6. A centralized managing system as claimed in claim 1, wherein the hub device includes a first hub connected with the at least one serial converting interface and a second hub connected to the at least one storage device.

7. A centralized managing system as claimed in claim 6, wherein the first and the second hubs are connected with each other via one selected from a group consisting of a coaxial cable, an internet line or a fiber cable.

8. A centralized managing system as claimed in claim 6, wherein the first and the second hubs are switch hubs, and the second hub is configured for distributing the second interface datum to the at least one storage device.

9. An integrated managing method, comprising steps of:
generating a first interface datum;
converting the first interface datum into a second interface datum;
distributing and storing the second interface datum; and
accessing and managing the second interface datum via an external network.

10. An integrated managing method as claimed in claim 9, wherein the first interface datum has a format being one selected from a group consisting of a IDE, a SCSI and a SATA formats which are accessible for an industrial device.

11. An integrated managing method as claimed in claim 9, wherein the second interface datum has a format being one selected from a group consisting of a FDDI, an Ethernet, a SAN, a NAS and an iSCSI formats which are accessible for an internet.

12. An integrated managing method as claimed in claim 9, wherein the second interface datum is distributed into at least one storage device by a hub device.

13. A remote managing system for an industrial data storage, comprising: an industrial apparatus outputting a first interface datum;
a serial converting interface connected with the connecting interface, and converting the first interface datum into a second interface datum; and
a storage device connected with the serial converting interface, and storing the second interface datum.

14. A remote managing system as claimed in claim 13, wherein the first interface datum has a format being one selected from a group consisting of a IDE, a SCSI and a SATA formats which are accessible for the industrial apparatus.

15. A remote managing system as claimed in claim 13, wherein the second interface datum has a format being one selected from a group consisting of a FDDI, an Ethernet, a SAN, a NAS and an iSCSI formats which are accessible for an internet.

16. A remote managing system as claimed in claim 13, wherein the storage device is connected with an external network, through which the second interface datum is accessed.

17. A remote managing system as claimed in claim 13, wherein the industrial apparatus comprises a connecting interface connecting with the serial converting interface.
